(19) United States
(12) Patent Application Publication
(10) Pub. No.: US 2007/0080144 A1
(43) Pub. Date: Apr. 12, 2007

(54) Tri-boss mounting device for high-voltage circuit breakers

(76) Inventors: Jeffry R. Meyer, Greensburg, PA (US); Daniel C. Schiffbauer, Uniontown, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/247,503

(22) Filed: Oct. 11, 2005

(51) Int. Cl. H01H 33/00

(52) U.S. Cl. 218/97

(57) ABSTRACT

A gas mounting device is provided for a high voltage circuit breaker operable to be fitted integrally on one end of a tank of the circuit breaker, said mounting device being substantially a ring shape and comprising at least three identical machined entries through the bottom of the ring such that access is obtainable through the mounting device into the tank. The gas mounting device allows for a gas system to be installed in a three phase circuit breaker.

### BACKGROUND

1. Technical Field

This invention relates to high-voltage circuit breakers. More specifically, this invention relates to a multi-phase high-voltage circuit breaker and devices for fitting onto the same.

2. Description of the Related Art

In high-voltage circuit breakers, sulfur hexafluoride (SF₆), either alone or in combination with some other gas such as nitrogen or tetrafluoromethane, may be used as both an electrical insulating medium and a current interrupting medium. As an electrical insulating medium, SF₆ allows for reduced gaps between high voltage components and ground potential surfaces. As a current interrupting medium, SF₆ enables the extinction of high current arcs across the circuit breaker contacts so as to accomplish the switching function, which is the main purpose of high voltage circuit breakers.

Circuit breakers having a three phase tank design are generally known in the art and may have various configurations, such as those described in U.S. Pat. Nos. 6,686,553; 6,437,276; and 4,027,125, the disclosures of each of which are herein incorporated by reference in their entirety. Typical three phase circuit breakers include three separate gas-insulated tanks or enclosures, which together operate to perform the interrupting action of the breaker. The three separate tanks are usually individually pressured and controlled, but they may share the same gas system through interconnected piping.

Every gas filled circuit breaker includes a means to fill and empty the gas in the tank of each phase of the circuit breaker. The gas piping from the three phase units is often connected together for ease of gas handling. Also, the gas temperature and pressure need to be sensed to allow concurrent monitoring or calculation of the gas density. In all three phases of the circuit breaker, the gas temperature must be maintained above a predetermined temperature to prevent liquefying of the insulating gas. Each of these functions requires entries into the enclosure or tank so that the gas and sensors may enter and exit the tank.

Entry into the tanks has been accomplished by machining or casting access holes at various locations on the enclosure wall and adding relatively long lengths of conduit, cable, or piping that lead to the control cabinet of the circuit breaker. Long lengths of gas piping in cold weather conditions require that heaters be added to the pipe and that insulation be wrapped over them to prevent gas from liquefying inside the piping. Typically, tank designs allow for entries into the interior cavity through the end cap of the tank, which is a cover that seals one end of the tank. The situation is further complicated in that the outboard phases of the circuit breaker are usually rotated outward relative to the center phase, destroying symmetry and complicating the conduit, piping, and cable runs to the cabinet. Such rotation is usually incorporated into the design of the breaker to provide adequate space for the bushings located on top of the three phase tanks.

The disclosure contained herein describes attempts to solve one or more of the problems described above.

### SUMMARY

In accordance with one embodiment of the invention, a gas mounting device for a high voltage circuit breaker, wherein the mounting device is operable to be placed fitted integrally on one end of a tank of the circuit breaker, the mounting device being substantially a ring shape and comprising at least three entries that are capable of accepting a peripheral device for ingress such that access is obtainable into the tank. The device may also contain one or more mounting mechanisms sized and positioned to accept an end cap. Another embodiment is a circuit breaker comprising the mounting device as described herein. With the mounting device, the machined entries are operable to place a tank heater, a particle trap, gas valves, piping, and monitoring or sensory equipment into the interior of the tank.

In another embodiment, a three phase circuit breaker includes three tanks, three gas mounting devices fitted integrally on at least one end of each of the tanks, and a piping system which connects the three tanks through the machined entries of the mounting device such that the three phases share a single gas system.

In another embodiment, a high voltage circuit breaker includes a first circuit breaker tank and a second circuit breaker tank. A first mounting device may be located at one end of the first tank and has a first removable end cap and a plurality of access points into the first tank. The first tank may have access points are not located on the first end cap. A second mounting device is located at one end of the second tank. The second mounting device has a second removable end cap and a plurality of access points into the second tank. The second tank access points are not located on the second end cap. A first conduit fluidly connects one of the first tank access points to one of the second tank access points. Optionally, a third circuit breaker tank includes a third mounting device located at one end of the third tank. The third mounting device has a third removable end cap and a plurality of access points into the third tank, and the third tank access points are not located on the third end cap. A third conduit fluidly connects one of the third tank access points to one of the second tank access points. One of the access points on each tank may accept a peripheral device, such as a tank heater, a particle trap, a monitor or a sensor, into the tank. Optionally, the second tank access points are located around a central position of the circuit breaker and the second tank, the first tank access points are located around a position on the first tank that faces the second tank, and the third tank access points are located around a position on the third tank that faces the second tank.

### BRIEF DESCRIPTION OF THE DRAWINGS

Various aspects and applications of the present invention will become apparent to the skilled artisan upon consideration of the brief description of the figures and the detailed description of the invention, which follows:

FIG. 1 illustrates an exemplary three-phase circuit breaker assembly.

FIG. 2 is a schematic of a mounting device according to an embodiment.

FIG. 3 is a schematic of a three phase circuit breaker employing three mounting devices according to an embodiment.

### DETAILED DESCRIPTION

Before the present devices and methods are described, it is to be understood that this invention is not limited to the particular designs, processes, compositions, or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred designs, methods, devices, and materials are now described. All publications mentioned herein are incorporated by reference in their entirety. Nothing herein is to be construed as an admission that the invention is not entitled to antedate such disclosure by virtue of prior invention.

The present invention may be included in existing and/or new circuit breaker designs. In various embodiments, the circuit breaker may be a high voltage circuit breaker, such as a circuit breaker designed to be operated at least approximately 69 kilovolts (kV), or between about 50 kV and about 800 kV, on at least the input or the output terminals. Other voltages are possible.

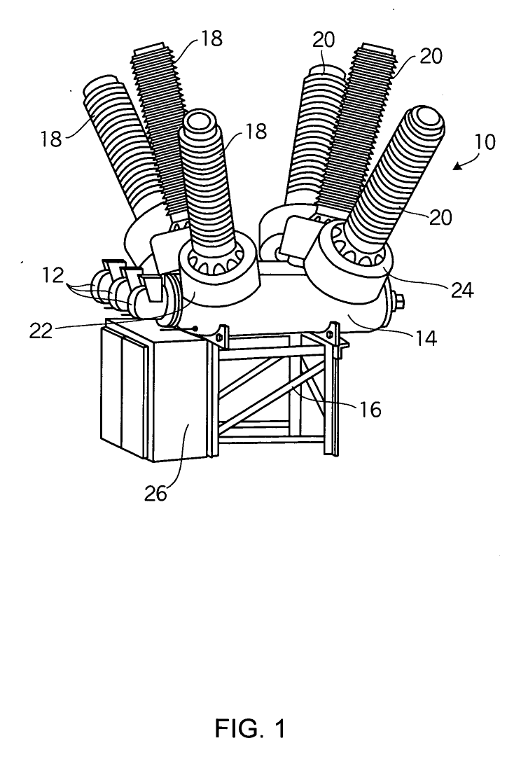

An example of a three-phase circuit breaker is illustrated in FIG. 1. Now referring to the drawings, FIG. 1 illustrates an exemplary three-pole circuit breaker 10 as found in the prior art. An exemplary circuit breaker 10 includes three horizontal circuit breakers 12, each having an exterior tank 14 mounted to a frame 16 supported on the ground. Optionally, the tanks 14 may be grounded to the frame 16, so that the circuit breaker 10 is a “dead tank” type circuit breaker. Each of the circuit breakers 12 may include an entrance insulator 18 and a corresponding exit insulator 20 extending outwardly from opposite sides of the respective tanks 14. The current transformers 22 and 24 are respectively mounted to each of the entrance and exit insulators 18 and 20 near the tank 14. Each of the circuit breakers 12 may have, contained within a tank 14, an operating mechanism and controller as are generally well-known for driving contact components within the tank 14, for selectively opening and closing a circuit between the respective entrance and exit insulators 18, 20. Suitable circuit breaker designs may include, for example any of the elements described in U.S. Pat. Nos. 3,852,548; 4,650,941; 6,307,172; 6,744,001; 6,686,553; 6,437,276; 4,027,125; 6,624,371; and 4,517,425, each herein incorporated by reference in its entirety. The tank 14 includes a contact mechanism that moves between an open position and a closed position. An insulating gas such as SF⁶ surrounds the contact mechanism in the tank to prevent arcing when the contact mechanism is open.

Typically, in gas-type circuit breakers, extinction of the arcs drawn between the contacts of the interrupter in the arcing area at the axial end of the movable contacts is aided by means of a blast of high pressure gas to the arcing area. The blast of high pressure gas may be released by operation of a blast nozzle. The opening operation of the blast nozzle may be synchronized with the opening of the contacts and may be accomplished by an associated linkage. A description of an exemplary blast nozzle, contacts and operating linkage may be found in U.S. Pat. No. 3,852,548, the disclosure of which is incorporated herein by reference in its entirety. Other examples of blast mechanisms include the circuit breakers described in U.S. Pat. Nos. 4,650,941; 6,307,172; and 6,744,001, the disclosures of each of which are herein incorporated by reference in their entirety. The gas serves a dual function of insulating the electronic components of the interior cavity and of extinguishing the arc as a blast or puff. The gas may be any insulating gas such as sulfurhexafluoride, tetrafluromethane, nitrogen, carbon dioxide, and mixtures thereof.

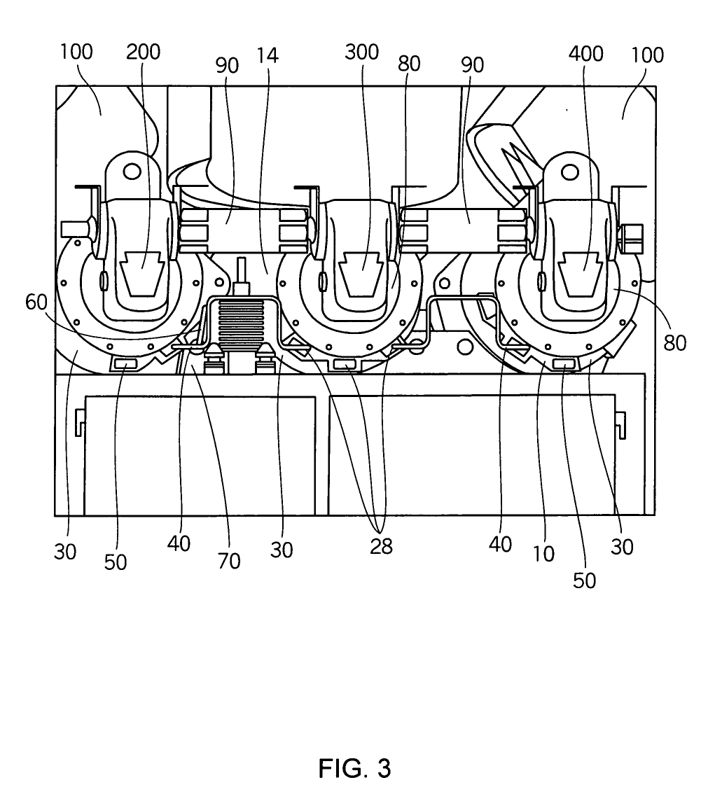

While a mounting device as described herein may be used in connection with any circuit breaker tank, the drawings used herein illustrate the mounting device when used in connection with a three phase circuit breaker such as is shown in FIGS. 1 and 3. attach piping or fittings. The mounting device allows for the necessary ingress into the tank cavity.

The entries are operable to place various elements or peripheral devices, such as a tank heater, a particle trap, gas valves, piping, and/or monitoring and sensory equipment into the interior cavity of the tank. Therefore, the mounting device eliminates the need to machine access holes directly into the tank wall for each such item, as is the prior art practice. Access holes and fittings have previously been placed through the end caps 80 of the tanks. Specifically, a heater tube may be placed into the interior cavity of the tank through one of the machined entries of the device. In addition, the tubing that connects the mounting brackets may itself be a peripheral device that exchanges or passes insulating gas between the tanks.

The mounting device may be designed such that multiple circuit breaker tanks or the multiple phase tanks of an individual breaker may be connected by appropriate piping. Additionally through the machined entries of the mounting device, the interior cavity of the tank of the breaker may be monitored by a control unit or housing. Therefore, any suitable monitoring and/or sensory equipment may be placed through the machined entries of the mounting device.

Another embodiment is a high voltage circuit breaker wherein each tank has a mounting device with three identical machined entries as described. A typical circuit breaker may include a contact mechanism movable between an open and closed position, a driving mechanism operable to drive the contact mechanism between the open and closed positions, and a tank having at least one wall defining an interior chamber enclosing the contact mechanism, the interior chamber being filled with an insulating gas. Suitable circuit breaker

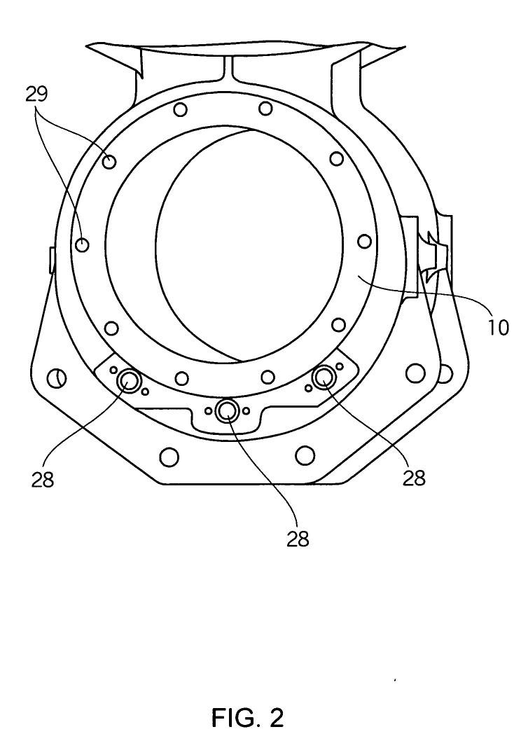

Referring to FIG. 2, one embodiment mounting device for a high voltage circuit breaker, may be fitted onto, or formed integrally with one end of a tank of the circuit breaker, the mounting device may have a ring shape and comprise at least three substantially identical entries 28 through the bottom of the ring such that access is obtainable through the mounting device into the tank. Other terminology for the mounting device 10 used herein includes “enclosure design” or “tri-boss” since it may have at least three functionality.

In some embodiments, the entries 28 are drilled, machined or cast into the mounting device 10 and may have a diameter of about 1.5 inch. Other sizes are possible. Optionally, the entries 28 may be threaded to accept peripheral devices such as conduit, hose or pipe and/or the like.

The mounting device 10 is preferably cast aluminum, although steel, copper or other sturdy materials may be used. The ring may include threaded receptacles 29 or other mounting mechanisms to which an end cap may be secured.

Mounting device 10 may be a separate ring of approximately two inches in thickness that is attached to a tank end by welding, bolting or other securing means. Other thicknesses are possible. Alternatively, mounting device 10 may be formed integrally with the tank. Preferably and optionally, the tank may include entries, such as ⅜-inch thick holes through the tank wall, sized and positioned to match entries 28 or the mounting ring so that an end cap may be removed from mounting ring 10 while any items inserted into entries 28 may remain in place.

As illustrated in FIG. 3, the mounting devices 10 and the machined entries 28 into the end of the tank eliminate the need to drill into the end cap 80 of the tank 14 so as to designs may include, without limitation and for example, the elements described in U.S. Pat. Nos. 3,852,548; 4,650,941; 6,307,172; 6,744,001; 6,686,553; 6,437,276; 4,027,125; 6,624,371; and 4,517,425, the disclosures of each of which are herein incorporated by reference in their entirety.

Another embodiment is a three phase circuit breaker comprising three tanks having at least one wall defining an interior chamber, the interior chamber being designed to be filled with an insulating gas, three identical mounting devices fitted integrally on at least one end of each of the tanks, each mounting device having substantially a ring shape and comprising at least three identical machined entries through a lower portion of the ring such that access is obtainable through the mounting device into the tank, and a piping system which connects the three tanks through the machined entries of the mounting devices such that the three phases share a single gas system.

Referring to FIG. 3, the entries 28 in the mounting device may be sealed by O-rings, caps, and other suitable fittings. The entries may accept conduit 40 or other functional elements to be included in the interior cavity of the tank. If one or more of the entries of the mounting device are not being used, it may be sealed or fitted with “blanks,” 50 such as to maintain a sealed interior cavity.

Alternatively, another embodiment includes fitting a mounting device inside the tank interior cavity. Thus, the end cap 80 of the tank may include pre-fabricated entries through the tank wall, which correspond to the entries through the mounting device. The mounting device with entries may provide support for the conduit and/or functional elements placed through the end cap wall of the tank to access the interior cavity. Therefore, the mounting device may be placed internally or externally with an end of the circuit breaker tank.

As seen in FIG. 3, attachment of piping, heaters, sensors, and required conduit is simplified by the use of mounting device 10. Also, rotation of the phase units or tanks does not complicate the design of these components. Three phases of a circuit breaker 200, 300, and 400 may be connected by employing three mounting devices 10. The mounting devices 10 may be rotated as seen in the outer phases 200 and 400. As illustrated, the center breaker 300 may have mounting device entry points centered substantially around a six o'clock position. Left breaker 200 may have mounting device entry points between about a 3 o'clock position and a 6 o'clock position. Right breaker 400 may have mounting device access points located from about a 6 o'clock position to about a 9 o'clock position. This allows for the manufacture and use of one mounting device for use in every phase of a three phase breaker. The devices 10 used in outer phases 200 and 400 are thus rotatable to allow for dielectric clearance for the bushings 100 located on top of the tanks 30.

Other positions are possible. Preferably, referring to FIG. 3, the positions are such that the central tank 300 access points are located around a central position (such as about a 12 o'clock position or about a 6 o'clock position) of the central tank 300. The leftmost tank 200 access points are preferably centered around a position on the leftmost tank 200 that faces the central tank 300 (such as a position that is between the 12 o'clock position and, moving clockwise around the end cap of tank 200, the 6 o'clock position). The rightmost tank 400 access points are located around a position on the rightmost tank 400 that faces the central tank 300 (such as a position that is between the 12 o'clock position and, moving counter-clockwise around the end cap of tank 400, the 6 o'clock position).

In some embodiments, one entry 50 on each mounting device 10 may used to attach a tank heater and/or a particle trap which extends into the interior cavity of the tank 30. Other entry points 20 may allow connection of gas valves and piping to either isolate the gas of each phase tank 30 or to connect the gas of the tanks/enclosures together. Suitable seals such as o-rings, double o-rings, welding, or other gasketing may be included in each entry such as to seal the interior cavity of the tank from the external environment. The piping 40 may be designed to eliminate the problem of gas liquidifying in cold weather without the need for auxiliary heating of the piping, any liquid naturally flowing into the warm enclosure to be boiled back into gas. One such design is on U-shaped piping 40 that connects the three phases of the breaker. The U-shape ensures that any liquidified SF₆ gas in the piping would not collect in the piping, but would enter the tank(s) through gravity feed.

For example, insulators around the piping may be added, especially for applications below about −45° C. One entry point may be used to mount a temperature/pressure probe for gas density monitoring of the tanks. This probe may be attached directly to the housing or control unit 70. Other entries and piping 60 may be used to connect the tank with the operation of the interruption mechanism. The horizontal rod 90 connecting the three phases preferably contains no gas and is used to operate the interruption functions of the circuit breaker.

The gas mounting device lowers the total circuit breaker cost while providing greater functionality and flexibility in configuring the circuit breaker for different customer requirements. The gas mounting device provides an accessible place for the component access machining, while allowing retrofitting on existing round pressure vessel shaped breakers.

The disclosed invention provides a modified mounting design with identical machined entries into the interior cavity of the tank which may be located very near to the control housing. While preferred embodiments have been described in detail, variations may be made to these embodiments without departing from the spirit or scope of the attached claims.

1. A mounting device for accepting devices into a tank of a high voltage circuit breaker, comprising:
first and second portions each sized and shaped to be positioned on an end of the tank, wherein the first portion defines at least three entries each sized and positioned to accept an individual peripheral device into the tank, and wherein the second portion is sized and positioned to accept an end cap.

2. The mounting device of claim 1, wherein the peripheral devices collectively comprise one or more of the following: a tank heater, a particle trap, a gas valve, a conduit, a pipe, a hose, a temperature sensor, and a pressure sensor.

3. The mounting device of claim 1, wherein the breaker comprises a three-phase circuit breaker, each tank of the circuit breaker includes one of the mounting brackets, and at least one entry on each bracket fitted with piping to connect another entry or another bracket on one of the other tanks.

4. The mounting device of claim 1, wherein the mounting device is substantially ring shaped.

5. The mounting device of claim 1, wherein at least one of the first and second portions is integral with the tank.

6. The mounting device of claim 1, wherein at least one of the first and second portions is comprised of one of following materials: an aluminum, a steel, and a copper.

7. The mounting device of claim 1, wherein at least one of the entries is threaded.

8. The mounting device of claim 1, further comprising a fitting positioned in one of the entries.

9. The mounting device of claim 8, where the fitting is an o-ring.

10. A high voltage circuit breaker comprising:
three circuit breaker tanks wherein:
each tank has a contact mechanism movable between an open and closed position;
each tank has a driving mechanism operable to drive the contact mechanism between the open and closed positions;
each tank has at least one wall defining an interior chamber enclosing the contact mechanism;
the interior chamber is filled with an insulating gas; and
a mounting device integrally fitted at one end of each tank, the mounting device comprising at least three entries that are sized and positioned to a peripheral device into the tank.

11. The breaker of claim 10, wherein the mounting device further comprises a securing mechanism sized and positioned to accept an end cap.

12. The breaker of claim 10, wherein the peripheral device comprises a tank heater, a particle trap, gas valves, piping, or monitoring or sensory equipment.

13. The breaker of claim 10, wherein each tank also includes at least three tank entries sized and positioned to accept a peripheral device into the tank, and wherein each mounting device is positioned so that the entries of the mounting device correspond to the location of the tank entries.

14. The breaker of claim 10, further comprising a conduit between two entries on different mounting devices.

15. The breaker of claim 14, wherein the conduit transfers gas from one tank to another tank.

16. A high voltage circuit breaker comprising:
a first circuit breaker tank; and
a second circuit breaker tank;
a first mounting device located at one end of the first tank, the first mounting device having a first removable end cap and a plurality of access points into the first tank, wherein the first tank access points are not located on the first end cap;
a second mounting device located at one end of the second tank, the second mounting device having a second removable end cap and a plurality of access points into the second tank, wherein the second tank access points are not located on the second end cap; and
a first conduit that fluidity connects one of the first tank access points to one of the second tank access points.

17. The circuit breaker of claim 16, further comprising;
a third circuit breaker tank;
a third mounting device located at one end of the third tank, the first mounting device having a third removable end cap and a plurality of access points into the third tank, wherein the third tank access points are not located on the third end cap; and
a third conduit that fluidly connects one of the third tank access points to one of the second tank access points.

18. The circuit breaker of claim 16, wherein:
one of the first tank access points accepts a peripheral device into the first tank;
one of the second tank access points accepts a peripheral device into the second tank; and
one of the third tank access points accepts a peripheral device into the third tank.

19. The breaker of claim 16, wherein each peripheral device comprises a tank heater, a particle trap, a monitor or a sensor.

20. The circuit breaker of claim 16, wherein:
the second tank access points are located around a central position of the circuit breaker and the second tank;
the first tank access points are located around a position on the first tank that faces the second tank; and
the third tank access points are located around a position on the third tank that faces the second tank.

21. The mounting device of claim 1, wherein the first portion partially surrounds the second portion.

22. The mounting device of claim 1, wherein the second portion defines a plurality of receptacles.

23. The mounting device of claim. 22, wherein at least one of the receptacles is threaded.

24. The mounting device of claim 8, wherein the fitting is a cap.
